(19) United States
(12) Patent Application Publication
(10) Pub. No.: US 2016/0278353 A1
(43) Pub. Date: Sep. 29, 2016

(54) Method and Apparatus for Controlling Fish

(71) Applicant: Atlantic Lionshare Ltd., Hamilton (BM)

(72) Inventors: Elizabeth Childs Martin, Hamilton (BM); Darius Alan Martin, Hamilton (BM)

(73) Assignee: Atlantic Lionshare Ltd., Hamilton (BM)

(21) Appl. No.: 14/691,447

(22) Filed: Apr. 20, 2015

(30) Foreign Application Priority Data
Mar. 25, 2015 (GB) 1505074.3

(51) Int. Cl. A01K 79/02; B63B 35/24; B63G 8/00; A01K 99/00

(52) U.S. Cl. CPC A01K 79/02; A01K 99/00; B63B 35/24; B63G 8/001; B63G 2008/005

(57) ABSTRACT

A method of controlling a target species using a first ROV and second ROV, by manoeuvring a probe attached to the first ROV to be positioned around the body of an individual of a target species, deploying a high tensile voltage between the terminals of the probe to stun and or kill the target species, and using a capturing arrangement attached to the second ROV to guide, direct or move the stunned or killed individual into a storage container attached to the second ROV. An ROV for collecting and transporting a target species may comprise at least one capturing arrangement to guide, direct or move a stunned or killed individual of the target species into the storage container.

### BACKGROUND OF THE INVENTION

The invention relates to a method and apparatus for controlling fish and in particular, a method of killing and or capturing invasive species of fish, such as lionfish, with virtually no by-catch.

Invasive species of fish are proving to be devastating to the local environment and impact on the local economy. For example, in the west Atlantic, lionfish have been introduced from their native region of the Indian and Pacific oceans around the Philippines. In the west Atlantic, the species has no natural predators and is thriving in the new habitat.

In recent times, lionfish are reported as a problem in Bermuda, the Caribbean, USA and parts of the Gulf of Mexico and South America, and the population spread and population density continue to grow rapidly. Lionfish populations may be found in large numbers at depth as well as in shallower waters and they are happy in a range of habitats such as coral reefs, artificial reefs, mangroves and sea grass beds. The fish are having a big impact on the native species and coral reef, on which they feed.

The lionfish are also impacting on commercial interests and represent a risk to health, as the lionfish have venomous spines. This affects recreational and commercial fishing, the tourist industry divers, snorkelers, and swimmers. Lionfish are also having an impact around oil rigs.

Accordingly, there is a need to mitigate the negative impacts of the lionfish by continuous management of their population, by monitoring and removal of the fish. Management of their population is difficult because of the risk from their venomous spines.

Spear fishing techniques are used but the small numbers of fish that are caught and the level of safety equipment required means that it is inadequate to effectively manage the population growth. Lobster trappers report that lionfish are often caught in large numbers in lobster traps, but this is incidental and is not enough to control their population in the diverse habitats that they populate. There are no current commercial fishing techniques.

Other techniques of controlling and monitor fish, mainly with farmed salmon and trout, populations include stunning the fish with a handheld electrical probe. However, if the fish are not captured and brought to the surface they may recover and continue to breed and inhabit the area where the population is a problem.

There is a need to develop technology to efficiently manage the fish population using trapping, deep water culling, and shallow water culling solutions while minimising the risk to health and by-catch.

### SUMMARY OF THE INVENTION

One aspect of the invention provides a method of controlling a target species using a first remotely operated underwater vehicle (ROV) and second ROV, wherein the method comprises the steps of: (a) manoeuvring a probe attached to the first ROV to be positioned around the body of an individual of a target species; (b) deploying a high tensile voltage between the terminals of the probe to stun and or kill the target species; and (c) using a capturing arrangement attached to the second ROV to guide, direct or move the stunned or killed individual into a storage container attached to the second ROV.

Another aspect of the invention provides a system for controlling a target species comprising: a first ROV, wherein the first ROV includes a high tensile voltage probe; and a second ROV, wherein the second ROV includes at least one capturing arrangement and a collection storage container, wherein the ROVs may be operated to work collaboratively to locate and collect individuals of a target species.

Another aspect of the invention provides an ROV for killing and or stunning a target species comprising: at least one high tensile voltage probe.

Another aspect of the invention provides an ROV for collecting and transporting a target species comprising: at least one capturing arrangement to guide, direct or move a stunned or killed individual of the target species; and a storage container, wherein the at least one capturing arrangement guides, directs or moves the individual into the storage container.

Thus, a target species may be effectively controlled using the method or system and or ROVs. By remotely operating the ROVs, the system minimises risks of stings caused by the spines of venomous or poisonous species. Further, the ROVs are able to operate at depths much greater than those accessible by divers, and without tiring. Still further, as the process is generally methodical, it can be used to count or monitor the population of the target species in a certain area. This enables the assessment of whether the population control is effective or if more is needed to keep the population in check. The method is a humane way of controlling a population of a target species and may be used to catch both adult and juvenile fish. Further, as the method and or system does not cause destruction of the fish, the catch may be used in the restaurant or food industry as the fish provides a valuable source of protein. This provides both incentives to catch the target species and provides a source of income.

A surface vessel may be used to deploy one or more ROV(s). The ROVs may be controlled via a tether by an operator in a surface vessel. Each of the ROVs may be attached to one end of a tether and the other end of the tether may be attached to a surface vessel. This ensures that the ROVs are controlled by the surface vessel.

The operator may also employ scout boats to assist in locating an area containing a target species.

To collect the target species, the operator may use the tools attached to the ROV to open a door of the storage container attached to the second ROV before the target species is guided, directed or moved into the storage container and close the door once the target species is within the storage container. When the container is full, the ROV may return to the surface to be emptied by lifting the second ROV to the deck and releasing doors on the bottom of the storage container to remove the target species from the storage container. The target species may then be prepared and packaged for shipping.

The first ROV may comprise two spaced apart probe arms, to be used for stunning or killing a fish.

The second ROV may comprise an articulated arm and or at least one collection basket. The capturing arrangement may be a controllable jaw which is controllable by the operator. In a preferred arrangement, a first capturing arrangement is located on the front of the storage container, a second capturing arrangement is located on the frame of the ROV, and the storage container is attached to the bottom of the ROV. Preferably, the storage container further comprises a first door covering at least one opening and movable between an open and a shut position. Further, the storage container has a boxed section, located behind the at least one opening. Preferably, the boxed section may have a second door, movable between an open and a shut position, which is movable by hydrologic motion. The storage container may contain up to 500 individuals of the target species. The storage container may have a cage construction.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1a is a schematic diagram of a target species in position between the probes.

FIG. 1b is a schematic diagram of guiding the target species into the basket.

FIG. 1c is a schematic diagram of the target species in the basket.

FIG. 2 is a front-side view of ROV1.

FIG. 3 is a top view of ROV1.

FIG. 4 is a top view of ROV1.

FIG. 5 is a front-side view of ROV1.

FIG. 6 is a front-side view of ROV2.

FIG. 7 is a back-side view of ROV2.

FIG. 8 is a side-front view of ROV2.

FIG. 9 is a top side view of the basket.

FIG. 10a is a top-back view of ROV2 separated from the basket.

FIG. 10b is a top-front view of ROV2 separated from the basket.

FIG. 11 is a top-side view of the basket.

FIG. 12 is a portion of an internal view of the basket.

### DETAILED DESCRIPTION OF PREFERRED EMBODIMENTS

Referring to the drawings, like reference numerals designate identical or corresponding features throughout the views.

In overview, the invention relates to a method of catching and killing and/or stunning an individual of a target species using remotely operated underwater vehicles (ROVs). There are many types of ROVs available today. According to the invention, two ROVs are used. The ROVs used for the invention can be readily modified from basic models in order to carry out the specific tasks required in the environment in which they are required to operate.

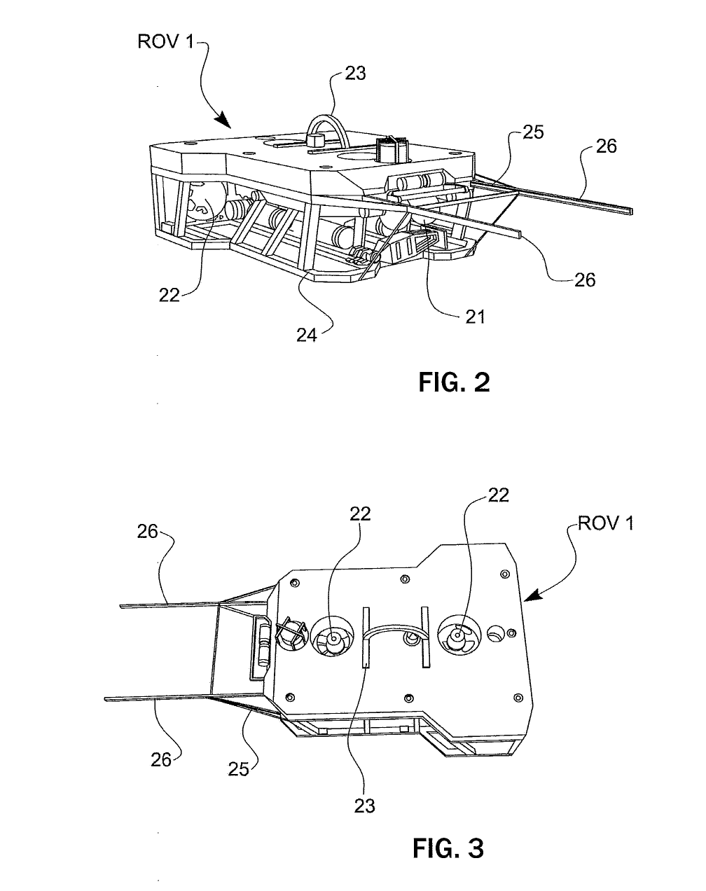

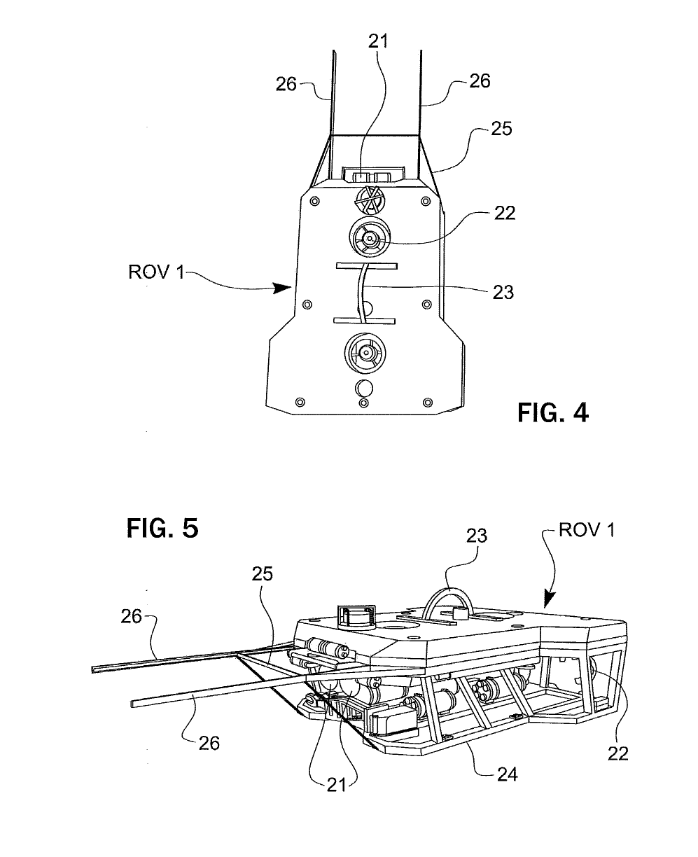

FIGS. 2 to 5 illustrate an embodiment of ROV1 suitable for carrying out a method of collecting a target species. ROV1 is a relatively light and manoeuvrable ROV that is able to accelerate and turn quickly.

In one embodiment, ROV1 is suitable for operating between depths of 0 m to 500 m and is a machine that is agile and able to be manoeuvred to find a targeted species. ROV1 may be equipped with a search light and at least one camera 21 which may be remotely operated from the surface vessel.

The light/camera 21 are used together by the operator in order to quickly and effectively locate an individual fish of a target species in a designated area. The locating equipment is suitable for use over the full depth range (up to 500 m) and in a diverse range of habitats. ROV1 is typically a small machine, relative to ROV2, that is capable of moving relatively quickly around reef habitats and other habitats which are likely to be identified as harvest areas for the targeted fish.

The ROV1 has a handle 23 on the upper surface, suitable for attaching a hoist. Towards the back of the ROV1 and towards the upper surface are mounted propellers 22 that may be controlled for manoeuvring the ROV1. Towards the font of the ROV1 are mounted a light and at least one camera 21 for locating individual fish. Additional cameras may be mounted at other locations on the ROV to provide a wider field of view. Other components of the ROV will be known to those skilled in the art. Power is preferably supplied to the ROV via the tether (not shown) connected to the surface vessel. Control signals are preferably received by the ROV via the tether cable. Typically a frame 24 surrounds the components of the ROV so that they do not become damaged during use, and to provide strength and stability to the structure.

ROV1 is modified from a standard ROV to include a high tensile voltage probe 25. The probe 25 is mounted on the front of ROV1 and includes two arms 26 extending away from the body of the ROV, approximately 15-20 cm. The arms 26 of the probe 25 are preferably arranged so that they are parallel and spaced approximately 30-50 cm apart. The position and proportions of the probe arms 26 allow them to be easily positioned around the body of a fish by manoeuvring the ROV. Of course, other arrangements of the probe arms 26 that are suitable to be positioned around the body of an individual fish are possible.

Typically, the probes arms 26 are made from stainless steel 316 so that they are suitable for use in salt water conditions and are electrically insulated from the ROV frame. For example, the arms may be insulated from the frame by 90 Shore Rubber and or a special waterproof epoxy coating.

The probe 25 is preferably connected to a high tensile voltage power supply on the surface vessel via an insulated cable that is inside the tether. The power supply is controlled by the ROV operator. When the probe 25 is activated by the operator, a high tensile voltage passes between the probe arms 26. The voltage may be 8V-15V and preferably around 12V.

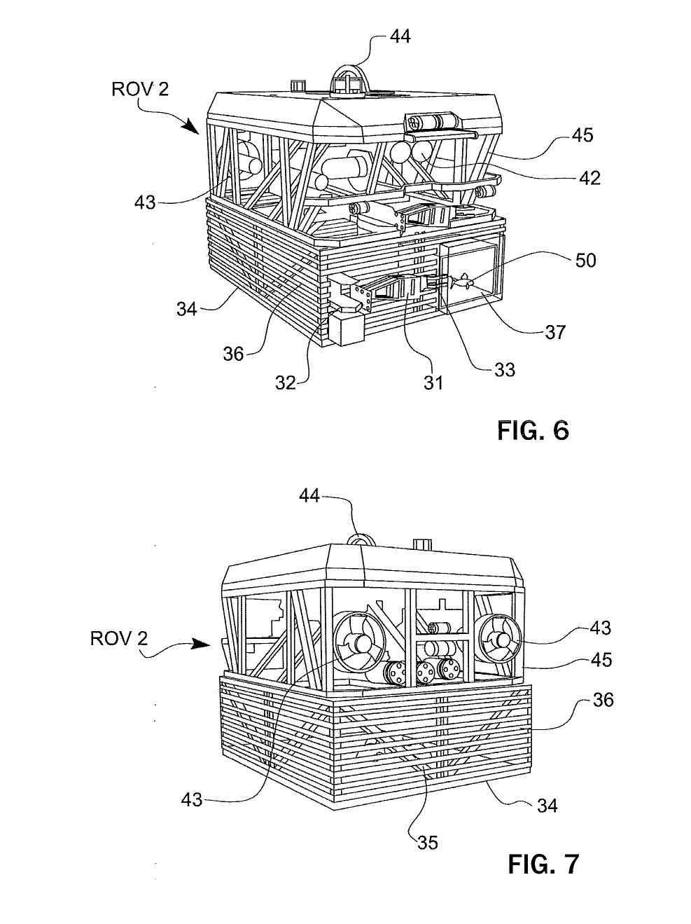

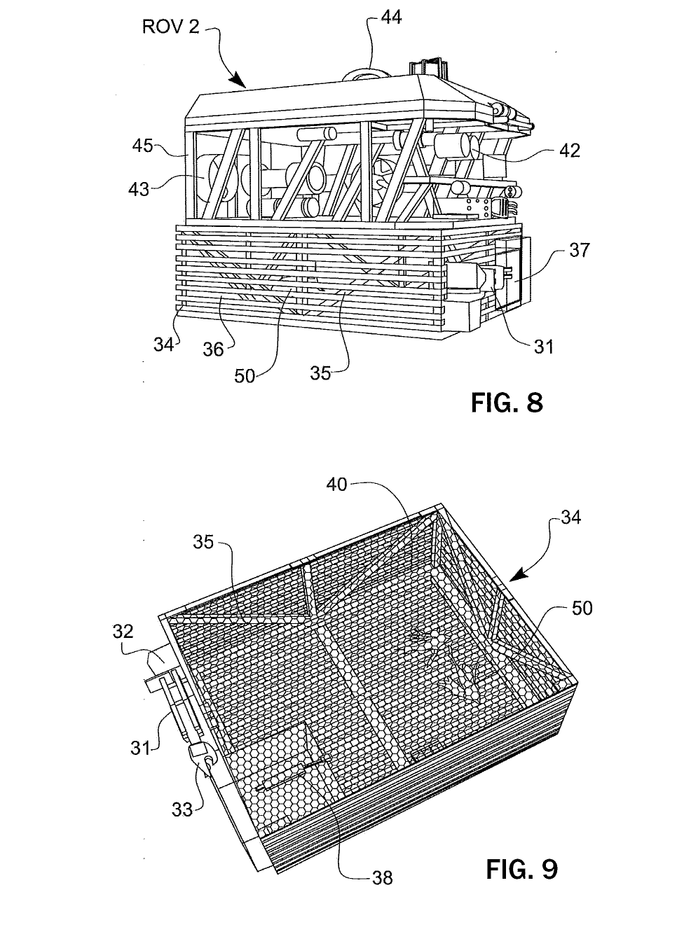

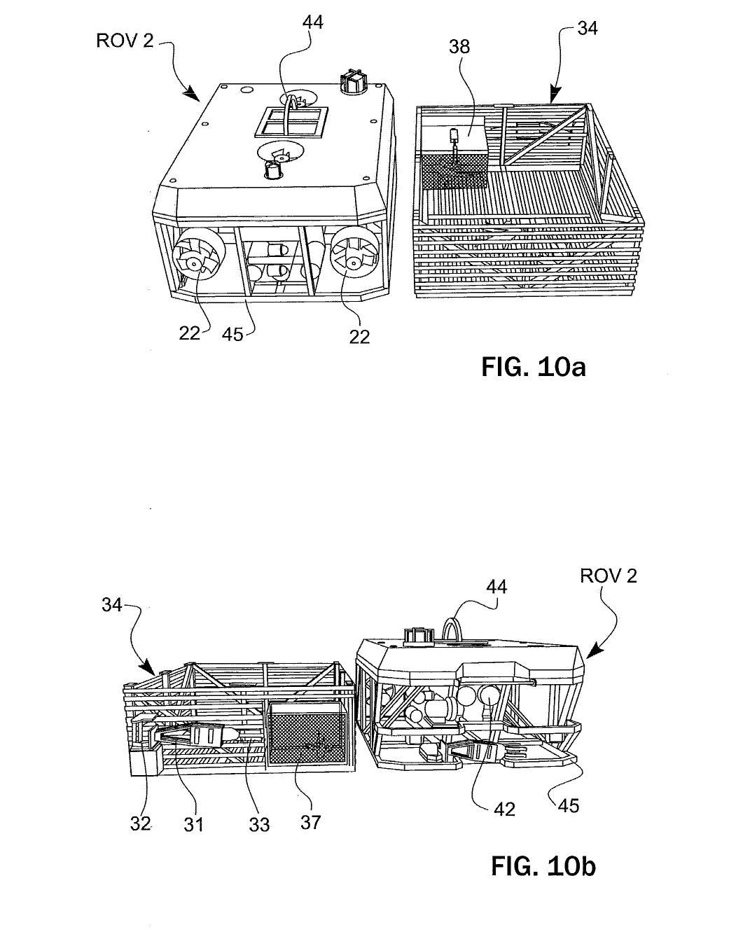

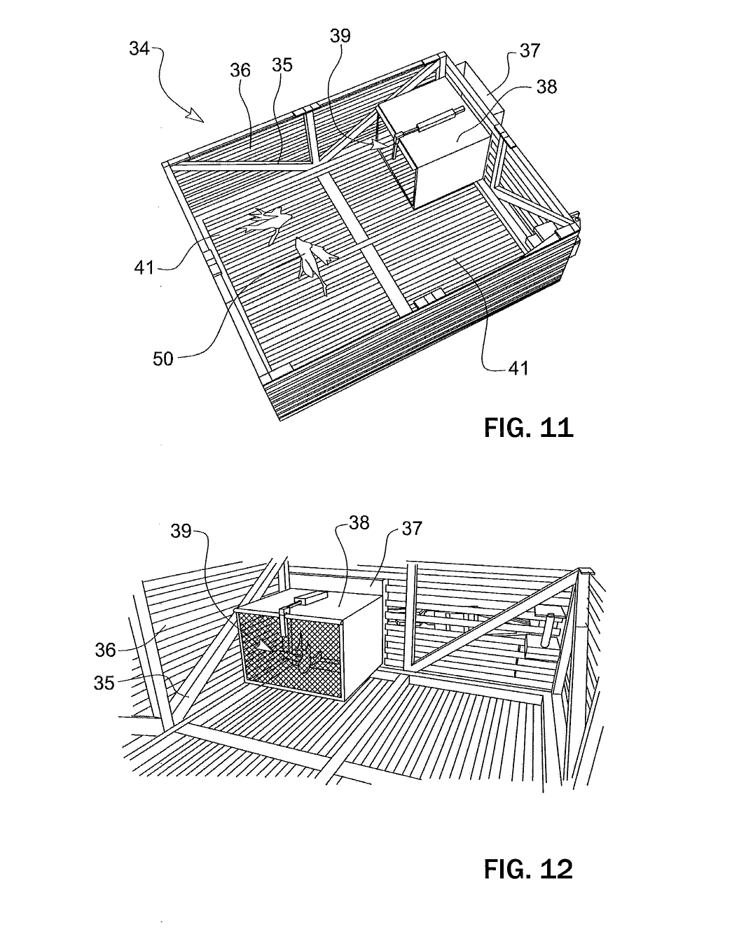

An embodiment of ROV2 and a storage container or basket arrangement are illustrated in FIGS. 6 to 12. ROV2 is suitable for use with ROV1 for carrying out a method of collecting a target species. Relative to ROV1, ROV2 is less manoeuvrable but capable of carrying a greater payload.

Similarly to ROV1, ROV2 is modified from a basic ROV. The ROV has a handle 44 on the upper surface, suitable for attaching a hoist. Towards the back of the ROV and on the upper surface are mounted propellers 22 that may be controlled for manoeuvring the ROV. Towards the font of the ROV are mounted a light and at least one camera 42 for locating fish to be captured. Additional cameras may be mounted at other locations on the ROV to provide a wider field of view. Other components of the ROV will be known to those skilled in the art. Power is preferably supplied to the ROV via the tether (not shown) connected to the surface vessel. Control signals are also preferably received by the ROV via the tether cable. Typically a frame 45 surrounds the components of the ROV so that they do not become damaged during use, and to provide strength to the structure.

The second ROV, ROV2 is necessarily a much larger and heavier ROV than ROV1 in order to carry the basket 34. Therefore, it is less manoeuvrable than ROV1 but still able to manoeuvre sufficiently for fish collection within the harvesting area.

ROV 2 is modified to include at least one arm 31 or other capturing arrangement for wafting, guiding or otherwise moving the killed fish and a basket 34 or other suitable container for collecting and containing fish in order to bring them to the surface.

The basket 34 is attached to the bottom face of the ROV frame 45. The basket 34 has a similar footprint to the ROV in order to maximise the capacity of the basket 34 while allowing the ROV to be controlled without modification to the control system.

The basket 34 has a large capacity so that ROV2 can remain under water collecting fish for as long as possible. If the basket 34 becomes full, ROV2 may return to the surface so that the basket 34 may be emptied. For example, the basket 34 may be large enough to contain up to 500 fish, approximately 225 kg of fish. In the embodiment illustrated in the drawings, the basket 34 has a cage construction made with horizontal stainless steel bars 36 attached to a frame, which is reinforced with vertical and diagonal bracing bars 35. The cage bars 36 have suitable spacing so that the basket 34 can contain the captured fish. The bottom of the basket is also enclosed with bars 36. The bottom of ROV2 acts as the roof of the basket 34. Further, a wire mesh 40 covers the roof of the basket 34, in case the basket 34 accidently becomes detached from the ROV. Thus, the basket 34 is fully enclosed so that captured fish cannot escape or float out after they have been collected.

On one side, on the front of the basket 34 there is an opening to allow fish to enter the basket 34. The opening has a first door 37 that is controllable by the operator. The door 37 may swing open when pushed by the articulated arm or by hydrologic motion. Behind the door 37 is a small boxed off volume 38 of the cage. The box 38 is suitably sized to contain one or more target fish. On the face opposite the cage opening is a second door 39. Effectively the boxed off volume 38 of the cage is akin to an airlock. The second door 39 may be opened after the first door 37 is closed by a hinge mechanism. In a preferred arrangement, the hinge may open the second door 39 passively due to the pressure of the water when the ROV next moves forwards, i.e. the second door 39 is hydrologic. This arrangement also pushes the incapacitated fish from the boxed off volume 38 to the main body of the basket 34, and without risking fish already captured being able to float out of or escape from the basket. When the basket 34 is full, fish are no longer able to move from the boxed off volume 38 to the main body of the basket 34. The operator may verify that the basket 34 is full using one of the cameras 42 or 21.

Mounted on the front of the cage 36 at the opposite end to the first opening, is a first articulated arm 31. The arm 31 hinged at its fixing point 32 and at the end opposite the fixing point is a jaw or claw 33. The arm 31 preferably has a full range of movement and is able to move up, down, swing left and right and the jaw 33 is able to rotate 360° relative to the arm fixing point 32. The arm 31 is controlled by the operator, via the tether cable.

A second arm 31 is mounted to the frame 45 on the front of ROV2, just above the basket 34. The second arm 31 has a similar range of movement to that of the first arm 31 and is similarly controlled by the operator.

As mentioned above, the bottom of the basket 34 is enclosed with bars 36. Not shown in the illustrations, these bars 36 may be divided and fitted into door frames. Thus, when ROV2 is at the surface, the bottom doors or ‘hatch’ of the basket 34 may be opened by the deck-hands and the contents of the basket 34 may be removed and packaged.

In a preferred embodiment, the hatch doors are held shut by a steel pin and bearing arrangement, located to the side of the hatch doors. The pins may be easily removed and replaced by the deck-hands.

To carry out a method of killing or stunning and catching a target species, two ROVs are taken, in a surface vessel, to a fishing site and deployed to work underwater. The ROVs are operated from the surface vessel (or another location). The ROVs are operated using independent operating systems. The ROVs are independently manoeuvrable relative each other and to the surface vessel, however, they are preferably each attached to the surface vessel with a tether. Typically the tethers will have a length of approx. 500 m to allow for a suitable range of movement by the ROVs. The surface vessel may have additional equipment for assisting with identifying and locating the targeted species.

In order to find a harvesting location for the targeted species, the surface vessel may be in communication with a number of scout boats which take images of the ocean floor. This information is relayed to the operator aboard surface vessel to identify areas that contain the targeted species.

When the surface vessel arrives at a location for harvesting the targeted species, tethers are attached to the ROVs and the ROVs are deployed from the surface vessel—for instance by lowering they ROVs into the water by a crane. The ROVs are then manoeuvred to the ocean floor or another target site, by an operator while a deck-hand manages the tethers.

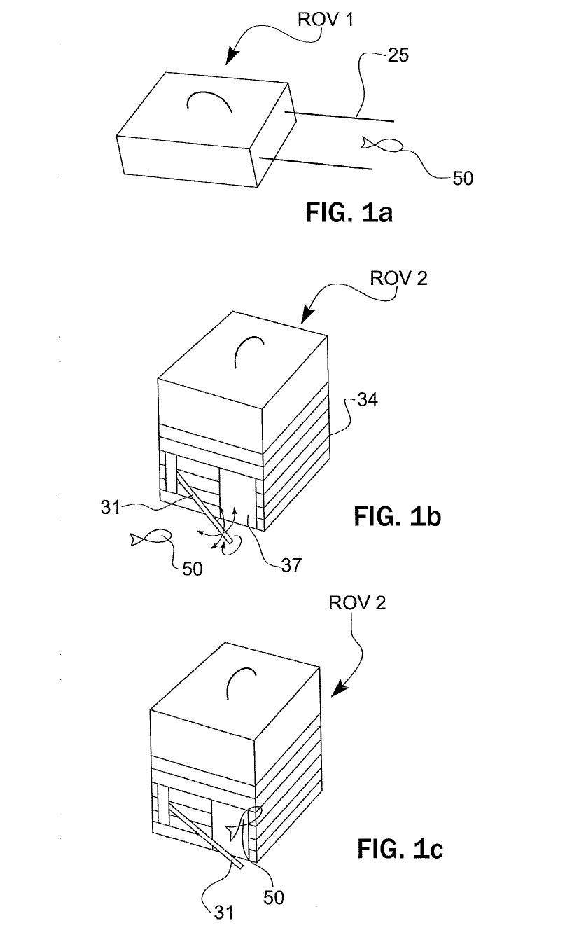

FIGS. 1a-c illustrate some of the basic steps of the method. More details of the method will become apparent to the skilled person from the subsequent description of the system's apparatus.

Once deployed, a first one of the ROVs (referred to here as ROV1) is used to locate an individual fish of the target species 50. ROV1 is agile and manoeuvrable and uses a light and at least one camera to locate the fish. Once a fish 50 is located by the operator ROV1 is manoeuvred into position and the probes 25 are placed on either side of the fish 50. The terminals of the probe 25 are positioned around the fish 50, and a high tensile voltage is applied across the terminals to stun or kill the fish 50 (FIG. 1a).

Meanwhile, a second operator manoeuvres a second ROV (referred to here as ROV2) close to ROV1 and the fish 50 (FIG. 1b). An arm 31 attached to ROV2 is used to waft, guide, direct or move the stunned or dead fish 50 into a collection basket 34, which is carried by or attached to ROV2. In the depicted embodiment, the basket 34 is attached to the underside of ROV2 (FIG. 1c).

The process of identifying fish, stunning or killing the fish 50 with ROV1 and collecting the fish 50 in the collection basket 34 continues until the area is cleared or there is a need for the ROVs to return to the surface (for example, when the basket is full). When the collection basket 34 is full, ROV2 returns to the surface and is lifted with the crane to the deck of the surface vessel, where the basket 34 is opened and emptied by deck-hands. Once the basket 34 is emptied, ROV2 can be immediately returned to the ocean to continue collect more stunned or killed fish of the target species.

While ROV2 is returning to the surface, ROV1 may remain on the ocean floor. As ROV1 is separately operated, ROV1 may continue to locate and stun or kill additional fish for collection when ROV2 returns to the ocean floor.

Thus, the two ROVs, ROV1 and ROV2, are operated independently by an operator on the surface vessel but work together in order to effectively clear an identified harvest area of the targeted species, and as efficiently as possible. As the fish are identified by an operator, the system can be used to kill specific fish species and thereby manage their population effectively.

The ROVs may be powered and controlled from the surface vessel via the tether. Thus, the ROVs can effectively operate for extended periods of time. When the particular location has been cleared of the target fish species, both ROVs may return to the surface and are hoisted onto the deck of the surface vessel so that the whole operation may relocate.

After the target species have been boxed, the fish may be processed for storage, packaging and shipping for sale. If the target species is a venomous species e.g. lionfish, the deck-hands may take appropriate precautions, such as wearing protective clothing, and remove the venomous parts of the fish before shipping

In an alternative method, ROV1 may be used to kill individuals of the target species. The fish could then be collected using a slurp gun or another method of collection. Alternatively, the target species may be killed by using a spear fishing or grabbing method and then collected by ROV 2.

In depths which are accessible to divers, a smaller hand held ROV may be used in place of ROV1 or ROV2.

ROV1 or ROV2 may be modified to include additional tools, such as sensors and or sonar.

These could be used to assist with the method. For example, sonars could be used to assist with locating the target species. Once the ROV arrives at the identified location, the fish could then be verified using visual identification.

The entrance to the basket could include a sensor which is triggered by the presence of an individual fish. This could automatically open the door of the cage to catch the fish or be used to count the number of individuals in the basket.

Alternatively to visual confirmation, object identification software could be used to locate and confirm the identity of the target species.

In alternative arrangement, the ROVs may carry battery packs and be operated by a remote control means rather than being tethered to the surface vessel.

While embodiments of the invention have been illustrated and described, it is not intended that these embodiments illustrate all possible forms of the invention. It is understood that various changes may be made without departing from the scope of the invention. Those of ordinary skill in the art will appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

When used in this specification and claims, the terms “comprises” and “comprising” and variations thereof mean that the specified features, steps or integers are included. The terms are not to be interpreted to exclude the presence of other features, steps or components.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A method of controlling a target species using a first ROV and second ROV, wherein the method comprises the steps of:
(a) manoeuvring a probe attached to the first ROV to be positioned around the body of an individual of a target species;
(b) deploying a high tensile voltage between the terminals of the probe to stun and or kill the target species; and
(c) using a capturing arrangement attached to the second ROV to guide, direct or move the stunned or killed individual into a storage container attached to the second ROV.

2. A method according to claim 1 wherein the ROVs are controlled via a tether by an operator in a surface vessel.

3. A method according to claim 1 wherein each of the ROVs is attached to one end of a tether and the other end of the tether is attached to a surface vessel.

4. A method according to claim 1, further comprising the step of deploying one or more ROV(s) from a surface vessel.

5. A method according to claim 1, further comprising the step of employing scout boats to locate an area containing a target species.

6. A method according to claim 1, further comprising the step of opening a door of the storage container attached to the second ROV before the target species is guided, directed or moved into the storage container and closing the door once the target species is within the storage container.

7. A method according to claim 1, further comprising the step of, in response to a sensor indicating that the storage container is full, returning the second ROV to the surface to be emptied, optionally, wherein when the second ROV has returned to the surface, lifting the second ROV to the deck and releasing doors on the bottom of the storage container to remove the target species from the storage container, and or further comprising the step of preparing and packaging the captured individuals of the target species for shipping.

8. An ROV for killing and or stunning a target species comprising:
at least one high tensile voltage probe.

9. An ROV according to claim 8, wherein the probe comprises two spaced apart probe arms.

10. An ROV for collecting and transporting a target species comprising:
at least one capturing arrangement to guide, direct or move a stunned or killed individual of the target species; and
a storage container, wherein the at least one capturing arrangement guides, directs or moves the individual into the storage container.

11. An ROV according to claim 10, wherein the at least one capturing arrangement is an articulated arm, optionally wherein the at least one capturing arrangement has a controllable jaw, and or wherein the at least one capturing arrangement is controllable by an operator, and or wherein a first capturing arrangement is located on the front of the storage container and or wherein a second capturing arrangement is located on the frame of the ROV.

12. A ROV according to claim 10 wherein the at least one storage container is a collection basket, optionally wherein the storage container is attached to the bottom of the ROV.

13. An ROV according to claim 10, wherein the storage container further comprises a first door covering at least one opening and movable between an open and a shut position.

14. An ROV according to claim 10, wherein the storage container has a boxed section, located behind the at least one opening.

15. An ROV according to claim 14, wherein the boxed section has as second door, movable between an open and a shut position, optionally, wherein the second door is movable by hydrologic motion, and or wherein the boxed section may contain a single individual of the target species.

16. An ROV according to claim 10, wherein the storage container may contain up to 500 individuals of the target species.

17. An ROV according to claim 10, wherein the storage container has a cage construction.

18. An ROV according to claim 10, wherein the storage container further comprises a hatch located on the bottom of the storage container, which is moveable between an open position and a dosed position, and make be locked in position, for removing the contents of the storage container.

19. An ROV according to claim 18, wherein the hatch is locked with a pin and bearing arrangement.

20. A system for collecting and transporting a target species, comprising an ROV according to claim 8 and a second ROV, the second ROV comprising:
at least one capturing arrangement to guide, direct or move a stunned or killed individual of the target species; and
a storage container, wherein the at least one capturing arrangement guides, directs or moves the individual into the storage container.
